(19) United States
(12) Patent Application Publication
(10) Pub. No.: US 2009/0195754 A1
(43) Pub. Date: Aug. 6, 2009

(54) IMAGE TRANSMITTING DEVICE, IMAGE TRANSMITTING SYSTEM, AND COMPUTER READABLE MEDIUM

(75) Inventor: Eisaku Hayashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/252,473

(22) Filed: Oct. 16, 2008

(30) Foreign Application Priority Data
Feb. 5, 2008 (JP) 2008-025794

(51) Int. Cl. G03B 21/00

(52) U.S. Cl. 353/31

(57) ABSTRACT

An image transmitting system includes: an image transmitting unit that receives a projection command to project an annotation image onto an object, and transmits a captured image formed by capturing an image of the object designated by the projection command as an object onto which the annotation image is to be projected, the annotation image representing an annotation about the object; a projector that projects the annotation image in an artificially continuous manner, using an afterimage formed by intermittently projecting light onto the object; and an image capturing unit that captures an image of the object including the portion onto which the light is projected during a period between a time when the projector ends the light projection onto the object and a time when the projector starts the next light projection, and forms the captured image to be transmitted by the image transmitting unit.

### CROSS-REFERENCE TO RELATED APPLICATION

This application is based on and claims priority under 35 USC 119 from Japanese Patent Application No. 2008-025794 filed Feb. 5, 2008.

### BACKGROUND

1. Technical Field

The present invention relates to an image transmitting device, an image transmitting system, and a computer readable medium.

2. Related Art

There has been a known type of image projecting device that can project an image reflected by a half mirror onto a position at which an image capturing device formed with a camera can perform image capturing, and can also cause attenuation of the light transmitted through the half mirror that affects the quality of the image captured by the image capturing device.

Also, there has been a remote conference support system that can obtain a written image formed by capturing an image of writing on a screen onto which an image to be used in a conference is projected.

### SUMMARY

According to an aspect of the invention, there is provided an image transmitting system includes: an image transmitting unit that receives a projection command to project an annotation image onto an object, and transmits a captured image formed by capturing an image of the object designated by the projection command as an object onto which the annotation image is to be projected, the annotation image representing an annotation about the object; a projector that projects the annotation image in an artificially continuous manner, using an afterimage formed by intermittently projecting light onto the object; and an image capturing unit that captures an image of the object including the portion onto which the light is projected during a period between a time when the projector ends the light projection onto the object and a time when the projector starts the next light projection, and forms the captured image to be transmitted by the image transmitting unit.

### BRIEF DESCRIPTION OF THE DRAWINGS

Exemplary embodiments of the present invention will be described in detail based on the following figures, wherein:

FIG. 1 illustrates the structure of an exemplary embodiment of an indicator system formed with an image transmitting system that includes an image transmitting device in accordance with the present invention;

FIG. 2 illustrates the positions of a projecting device, an image capturing device, and a half mirror;

FIG. 3 is a functional block diagram showing an example structure of the image transmitting device;

FIG. 4 illustrates an example hardware structure of the image transmitting device to be used for performing software control;

FIG. 5 schematically shows an example of the control operation to be performed by the controller of the image transmitting device;

FIG. 6 is a functional block diagram showing an example structure of the controller;

FIG. 7 is a flowchart showing an example of the drawing operation to be performed by the drawing unit;

FIG. 8 is a flowchart showing an example of the projection control operation to be performed by the projection controller;

FIG. 9 is a flowchart showing an example of the image capture control operation to be performed by the image capture controller;

FIG. 10 is a flowchart showing an example of the control operation to be performed by the controller;

FIG. 11 is a flowchart showing an example of the projection commanding operation to be performed by the projection commanding device;

FIG. 12 illustrates a situation where the projecting device is projecting light in a second exemplary embodiment;

FIGS. 13A and 13B illustrate an example structure of the converting unit in the second exemplary embodiment;

FIG. 14 illustrates a situation where the projecting device is not projecting light in the second exemplary embodiment;

FIG. 15 is a flowchart showing a part of the control operation to be performed by the controller of the projecting device in the second exemplary embodiment;

FIG. 16 is a flowchart showing the remaining part of the control operation to be performed by the controller of the projecting device in the second exemplary embodiment;

FIG. 17 schematically shows an example of the control operation to be performed by the controller of the image transmitting device in the second exemplary embodiment;

FIG. 18 is a flowchart showing an example of the projection control operation to be performed by the projection controller in the second exemplary embodiment;

FIG. 19 illustrates a situation where the projecting device is not projecting light in a third exemplary embodiment;

FIG. 20 illustrates an example structure of the converting unit in the third exemplary embodiment;

FIG. 21 is a flowchart showing a part of an example of the control operation to be performed by the controller of the projecting device in the third exemplary embodiment;

FIG. 22 is a flowchart showing the remaining part of the example of the control operation to be performed by the controller of the projecting device in the third exemplary embodiment; and

FIG. 23 schematically illustrates an example of the control operation to be performed by the controller of a projecting device in an example case where transmitted light is reflected so as to diverge from the object once in every two cycles.

### DETAILED DESCRIPTION

The following is a description of exemplary embodiments of the present invention, with reference to the accompanying drawings.

### First Exemplary Embodiment

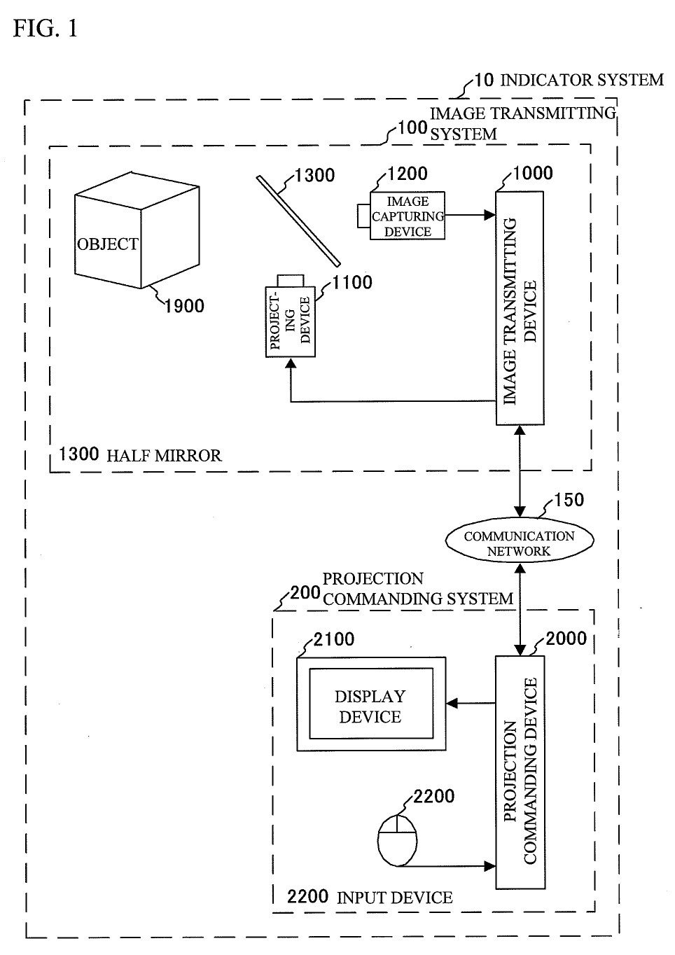

FIG. 1 illustrates the structure of an exemplary embodiment of an indicator system formed with an image transmitting system including an image transmitting device of the present invention.

An indicator system 10 shown in FIG. 1 includes an image transmitting system 100, a projection commanding system 200, and a communication network 150.

The image transmitting system 100 is a system designed to transmit a captured image of an object 1900 to be captured.

The image transmitting system 100 includes an image transmitting device 1000, a projecting device 1100, an image capturing device 1200, and a half mirror 1300 that are provided on the side of the object 1900.

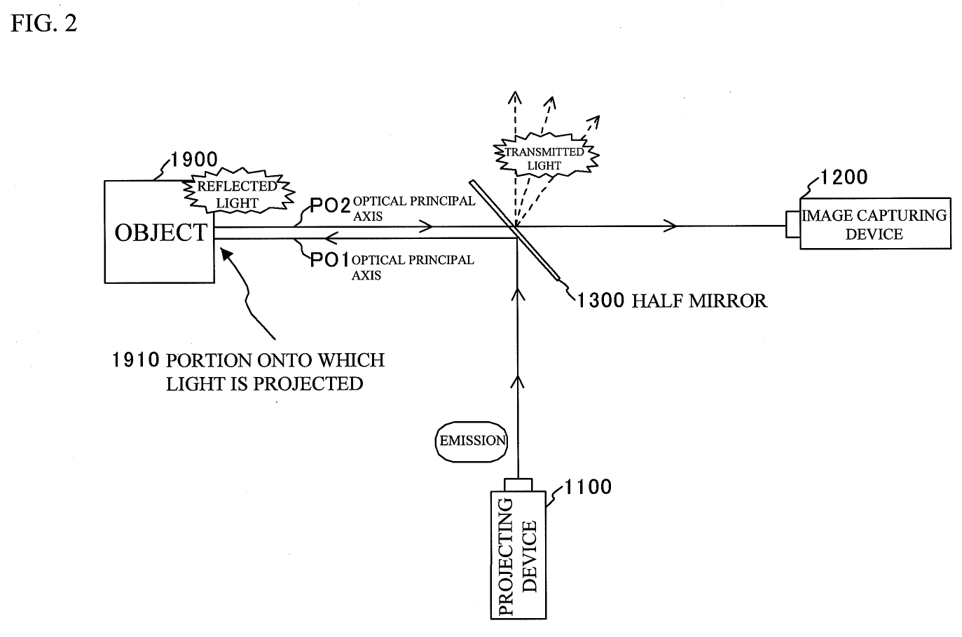

Prior to a description of the image transmitting device 1000, the projecting device 1100, the image capturing device 1200, and the half mirror 1300 are described with reference to FIG. 2. FIG. 2 illustrates the positions of the projecting device 1100, the image capturing device 1200, and the half mirror 1300.

The projecting device 1100 may be formed with a liquid crystal projector, for example, and is connected to the image transmitting device 1000. The projecting device 1100 is placed in such a manner that the optic principal axis PO1 of the projecting device 1100 via the half mirror 1300 is substantially the same as the optic principal axis PO2 of the image capturing device 1200 via the half mirror 1300.

Under the control of the image transmitting device 1000, the projecting device 1100 projects an annotation image indicating an annotation with respect to the object 1900 onto the object 1900 via the half mirror 1300.

In this exemplary embodiment, the projecting device 1100 is described as a device that causes the half mirror 1300 to reflect the light indicating an annotation image, and then projects the annotation image onto the object 1900.

Particularly, the projecting device 1100 projects an annotation image in a quasi-continuous manner, using the residual image formed by intermittently projecting light onto the object 1900.

More specifically, the projecting device 1100 intermittently projects light onto the object 1900 thirty times per second or more, so as to project an annotation image as if the annotation image were continuously projected, by virtue of an afterimage effect.

Every time the light projection is ended, the projecting device 1100 further outputs a signal indicating that the light projection is ended (hereinafter referred to simply as the “OFF signal”) to the image transmitting device 1000.

The image capturing device 1200 may be formed with a video camera or a Web camera, for example, and is connected to the image transmitting device 1000. The image capturing device 1200 is placed in such a position as to capture an image of the object 1900 and an annotation image projected onto the object 1900 by the projecting device 1100 via the half mirror 1300.

Under the control of the image transmitting device 1000, the image capturing device 1200 captures an image of the object 1900 including a portion 1910 via the half mirror 1300. The projecting device 1100 projects light onto the portion 1910.

In this exemplary embodiment, the image capturing device 1200 is described as a device that captures an image of the object 1900 from the light transmitted through the half mirror 1300.

The image capturing device 1200 further exposes the object 1900 to light over a predetermined period of time, and captures an image of the object 1900. Every time the image capturing device 1200 finishes capturing an image, the image capturing device 1200 outputs a signal indicating that image capturing is ended (hereinafter referred to simply as the “OFF signal”) to the image transmitting device 1000.

The period of time during which the image capturing device 1200 performs exposure to capture an image of the object 1900 will be hereinafter referred to simply as the exposure period.

The half mirror 1300 is formed with a beam splitter. The half mirror 1300 is placed in such a position that the reflected light of the light indicating an annotation image projected by the projecting device 1100 is emitted onto the object 1900, and the image capturing device 1200 can capture an image of the object 1900 and the image projected onto the object 1900 from the transmission light of the light reflected by the object 1900.

The half mirror 1300 transmits the light projected by the projecting device 1100 at the same time as reflecting the light indicating an annotation image projected by the projecting device 1100.

The light transmitted through the half mirror 1300 and the light reflected by the object 1900 serve as stray light to degrade the quality of each image to be captured by the image capturing device 1200.

Referring back to FIG. 1, explanation of the structure of the image transmitting system 100 is continued.

The image transmitting device 1000 may be formed with a personal computer, for example, and is connected to the projecting device 1100, the image capturing device 1200, and the communication network 150.

The image transmitting device 1000 receives a projection command to project an annotation image indicating an annotation about the object 1900 onto the object 1900, and transmits an image capturing the object 1900 to be designated as the projection object onto which the annotation image is to be projected through the projection command.

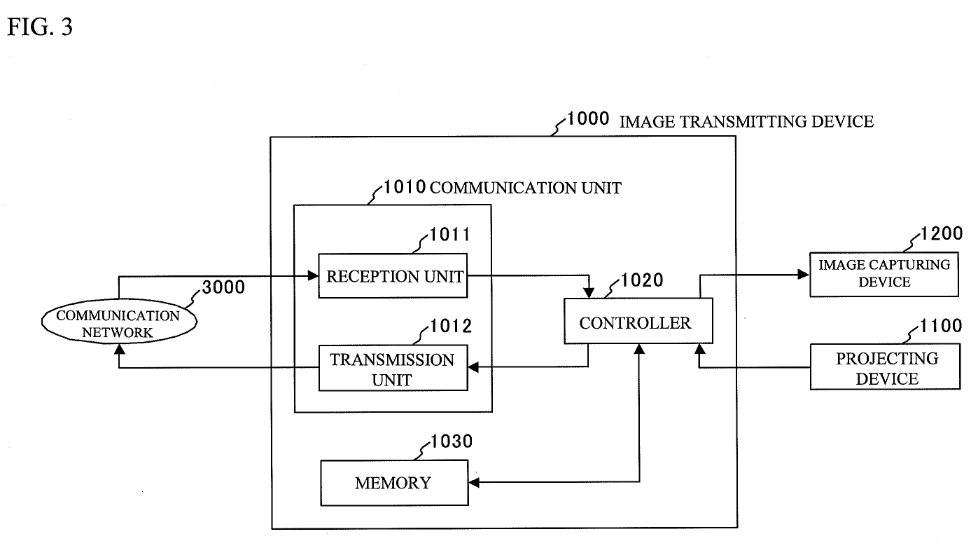

Referring now to FIG. 3, an example structure of the image transmitting device 1000 is described. FIG. 3 is a functional block diagram showing an example structure of the image transmitting device 1000.

The image transmitting device 1000 includes a communication unit 1010, a controller 1020, and a memory 1030. The functions of the communication unit 1010, the controller 1020, and the memory 1030 are realized through software control performed by the image transmitting device 1000.

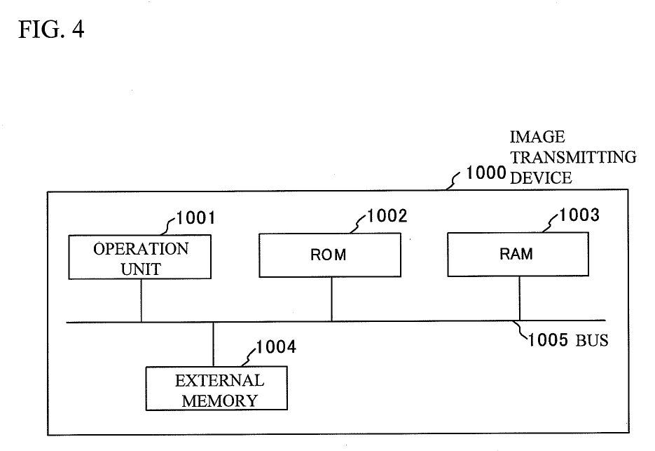

Referring now to FIG. 4, the hardware structure of the image transmitting device 1000 used to perform the software control is described. FIG. 4 illustrates an example of the hardware structure of the image transmitting device 1000 used to perform the software control.

The image transmitting device 1000 includes an operating unit 1001 such as a CPU (Central Processing Unit), a ROM (Read-Only Memory) 1002 such as an EPROM (Erasable Programmable Read-Only Memory) or an EEPROM (Electrically Erasable Programmable Read-Only Memory), a RAM (Random Access Memory) 1003 formed with a volatile memory such as a DRAM (Dynamic RAM) or a SRAM (Static RAM) or a nonvolatile memory such as a NVRAM (Non-Volatile RAM), and an external memory 1004 formed with a hard disk or the like. The operating unit 1001, the ROM 1002, the RAM 1003, and the external memory 1004 are connected to one another by a bus 1005.

The software control is realized by the operating unit 1001 reading a program stored in the ROM 1002 or the external memory 1004, and performing an operation according to the read program. The data about the operation result is written into the RAM 1003, and, in a case where the RAM 1003 is a NVRAM, data that requires backup when the power is turned off is stored into the RAM 1003.

Referring back to FIG. 3, explanation of the example structure of the image transmitting device 1000 is continued.

The communication unit 1010 may be formed with a network card, for example, and is connected to the communication network 150. The communication unit 1010 includes a reception unit 1011 and a transmission unit 1012, and exchanges information with the projection commanding system 200 connected to the communication unit 1010 via the communication network 150. The information the communication unit 1010 exchanges with the projection commanding system 200 will be described later.

The reception unit 1011 is connected to the controller 1020 and the communication network 150. The reception unit 1011 performs a later described receiving operation to receive a projection command to project an annotation image indicating an annotation about the object 1900 onto the object 1900.

An example of the receiving operation to be performed by the reception unit 1011 is now described.

First, the reception unit 1011 receives a projection command from the projection commanding system 200 via the communication network 150. The reception unit 1011 outputs the projection command to the controller 1020.

The reception unit 1011 then ends the receiving operation.

The transmission unit 1012 is connected to the controller 1020 and the communication network 150. The transmission unit 1012 performs a later described transmitting operation to transmit an image capturing the object 1900 designated as the object by the projection command to project an annotation image.

An example of the transmitting operation to be performed by the transmission unit 1012 is now described.

First, the transmission unit 1012 obtains an image captured by the image capturing device 1200 from the controller 1020. The transmission unit 1012 transmits the captured image to the projection commanding system 200 via the communication network 150. The transmission unit 1012 then ends the transmitting operation.

The controller 1020 is connected to the communication unit 1010, the memory 1030, the projecting device 1100, and the image capturing device 1200. The controller 1020 performs a later described control operation to control at least one of the projecting device 1100 and the image capturing device 1200 so that the image capturing device 1200 captures an image between the time when the projecting device 1100 ends the light projection onto the object 1900 and the time when the projecting device 1100 starts the next light projection.

In this exemplary embodiment, the controller 1020 is designed to control the image capturing device 1200 so as to capture an image between the time when the signal indicating the end of light projection (or the OFF signal) is obtained from the projecting device 1100 and the time when the projecting device 1100 starts the next projection. However, the present invention is not limited to that.

For example, the controller 1020 may control the projecting device 1100 to project light between the time when the signal indicating the end of an image capturing operation (or the OFF signal) is obtained from the image capturing device 1200 and the time when the image capturing device 1200 starts capturing the next image. The controller 1020 may control both the projecting device 1100 and the image capturing device 1200.

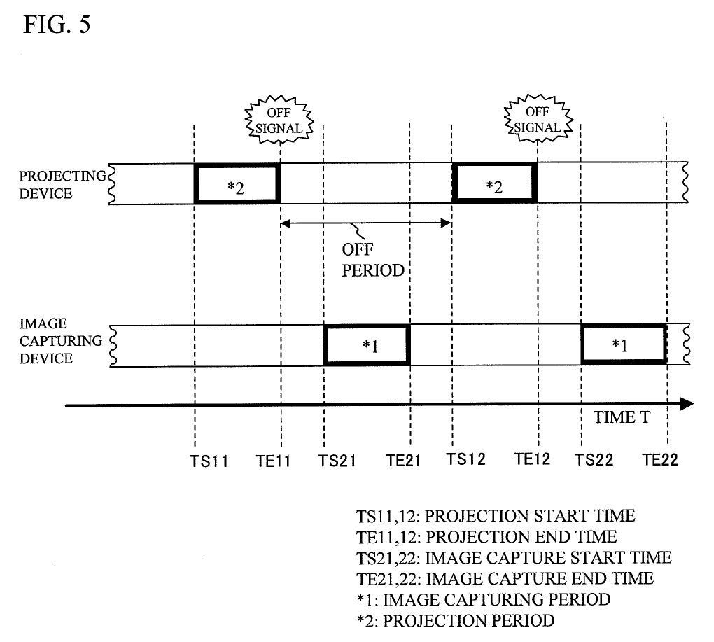

Referring now to FIG. 5, the control operation to be performed by the controller 1020 is described. FIG. 5 illustrates an example of the control operation to be performed by the controller 1020.

First, the controller 1020 controls the projecting device 1100 to project an annotation image during a projection period that is defined by the time TS11 at which projecting the annotation image is started (hereinafter referred to simply as the projection start time) and the time TE11 at which the projection is ended (hereinafter referred to simply as the projection end time).

The controller 1020 then controls the projecting device 1100 not to project light during the OFF period that is defined by the projection end time TE11 and the next projection start time TS12.

The controller 1020 also controls the image capturing device 1200 to start capturing an image of the object 1900 after obtaining the OFF signal output from the projecting device 1100 during the OFF period.

The controller 1020 further controls the projecting device 1100 so that the OFF period is longer than a predetermined exposure period of the image capturing device 1200. The controller 1020 also controls the projection period of the projecting device 1100 and the OFF period, so as to secure a time for projecting light in a quasi-continuous manner.

The length of the exposure period of the image capturing device 1200, the length of the projection period of the projecting device 1100, and the length of the OFF period are partially determined by the intensity of light projected by the projecting device 1100. Accordingly, the suitable length for each period of time can be defined based on experiments or a theory. In this exemplary embodiment, the length of the OFF period is set in the range of 1/100000 to 1/30 seconds.

The same applies to the projection period defined by the projection start time TS12 and the projection end time TE12, and the image capturing time defined by the image capturing start time TS22 and the image capturing end time TE22. Therefore, explanation of those times is omitted herein.

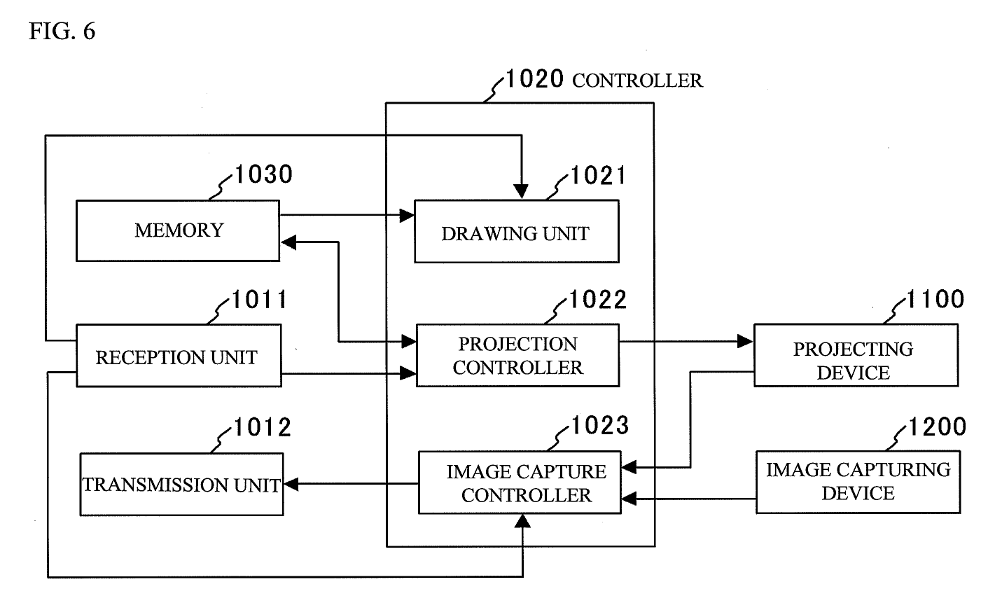

Before the control operation to be performed by the controller 1020 is explained, the structure of the controller 1020 is now described, with reference to FIG. 6. FIG. 6 is a functional block diagram showing an example structure of the controller 1020.

The controller 1020 includes a drawing unit 1021, a projection controller 1022, and an image capture controller 1023.

The drawing unit 1021 is connected to the reception unit 1011 and the memory 1030. The drawing unit 1021 performs a later described initial drawing operation and a later described actual drawing operation.

The initial drawing operation is performed to draw an initial image projected by the projecting device in an initial state before the controller 1020 receives a projection command. The actual drawing operation is performed to draw an annotation image designated through the projection command after the controller 1020 receives the projection command. The initial drawing operation and the actual drawing operation will be hereinafter referred to also as drawing operations.

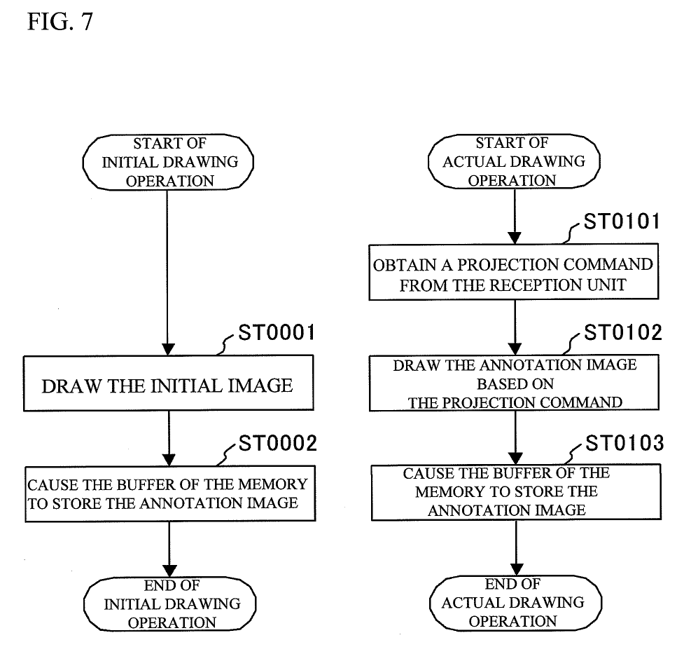

Referring now to FIG. 7, an example of the initial drawing operation to be performed by the drawing unit 1021 is described. FIG. 7 is a flowchart showing an example of the drawing operation to be performed by the drawing unit 1021.

First, the drawing unit 1021 draws an initial image (step ST0001). For example, the drawing unit 1021 opens an electronic file stored in the memory 1030, and reads the information defining the initial image from the opened electronic file. Based on the read information, the drawing unit 1021 draws the initial image.

The information defining the initial image includes at least one piece of information among the information defining the color of the background, the information defining the figure or character to be drawn, and the information defining the position of the figure or character to be drawn, for example.

The drawing unit 1021 then stores an annotation image into the buffer of the memory 1030 (step ST0002). After that, the drawing unit 1021 ends the initial drawing operation.

Referring again to FIG. 7, an example of the actual drawing operation to be performed by the drawing unit 1021 is described.

First, the drawing unit 1021 obtains a projection command from the reception unit 1011 (step ST0101). In accordance with the projection command, the drawing unit 1021 draws an annotation image (step ST0102).

For example, the drawing unit 1021 reads the information defining an annotation image from the projection command, and, based on the read information, draws an annotation image. The information defining the annotation image is the same as the information defining the initial image, and therefore, explanation of the information is omitted herein.

The drawing unit 1021 then stores the drawn annotation image into the buffer of the memory 1030 (step ST0103). After that, the drawing unit 1021 ends the actual drawing operation.

Referring back to FIG. 6, the structure of the controller 1020 is described.

The projection controller 1022 is connected to the memory 1030, the reception unit 1011, and the projecting device 1100. The projection controller 1022 performs a later described projection control operation to control the projecting device 1100 to project, in a quasi-continuous manner, an annotation image defined by a projection command received by the reception unit 1011, by virtue of a residual image formed by the light intermittently projected onto the object 1900.

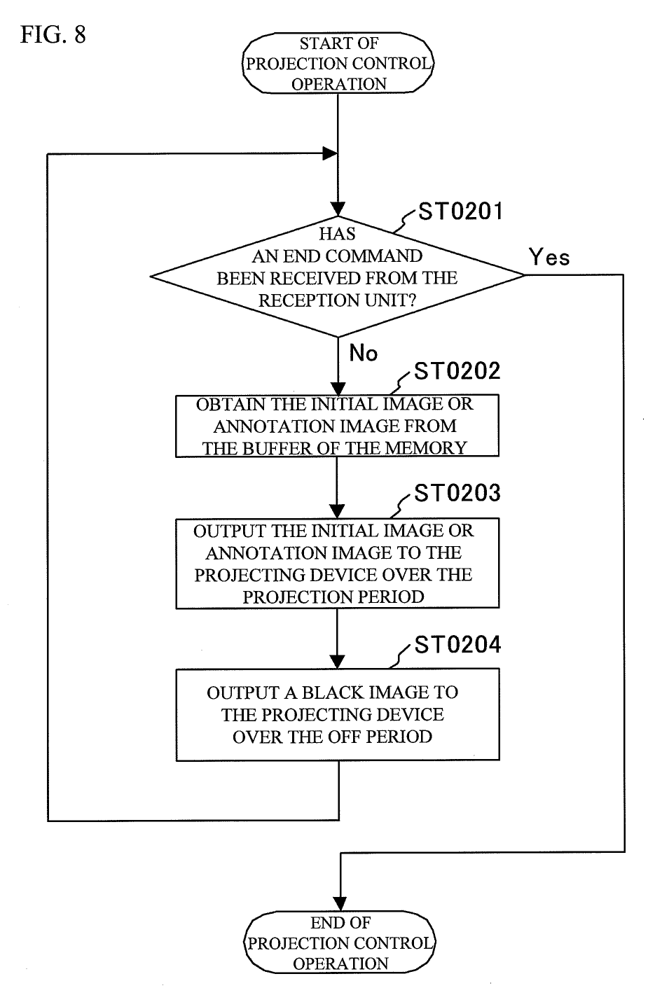

Referring now to FIG. 8, the projection control operation to be performed by the projection controller 1022 is described. FIG. 8 is a flowchart showing an example of the projection control operation to be performed by the projection controller 1022.

First, the projection controller 1022 determines whether an end command transmitted from the projection commanding system 200 has been received through the reception unit 1011 (step ST0201). If the end command has been received, the projection controller 1022 ends the projection control operation. If the end command has not been received, the projection controller 1022 carries out the procedure of step ST0202.

If the projection controller 1022 determines in step ST0201 that the end command has not been received, the projection controller 1022 refers to the initial image or the annotation image stored in the buffer of the memory 1030 (step ST0202).

The projection controller 1022 then outputs the initial image or the annotation image to the projecting device 1100 over the predetermined projection period. By doing so, the projection controller 1022 controls the projecting device 1100 to output the initial image or the annotation image (step ST0203).

The projection controller 1022 outputs a black image formed only with pixels representing the black color to the image capture controller 1023 over the predetermined OFF period. By doing so, the projection controller 1022 controls the projecting device 1100 to stop the light projection (step ST0204). The projection controller 1022 then returns to step ST0201, and repeats the above procedures.

Referring back to FIG. 6, explanation of the structure of the controller 1020 is continued.

The image capture controller 1023 is connected to the reception unit 1011, the transmission unit 1012, the projecting device 1100, and the image capturing device 1200. The image capture controller 1023 performs a later described image capture control operation to control the image capturing device 1200 to capture an image between the time when the projecting device 1100 ends the projection of light onto the object 1900 and the time when the projecting device 1100 starts the next projection.

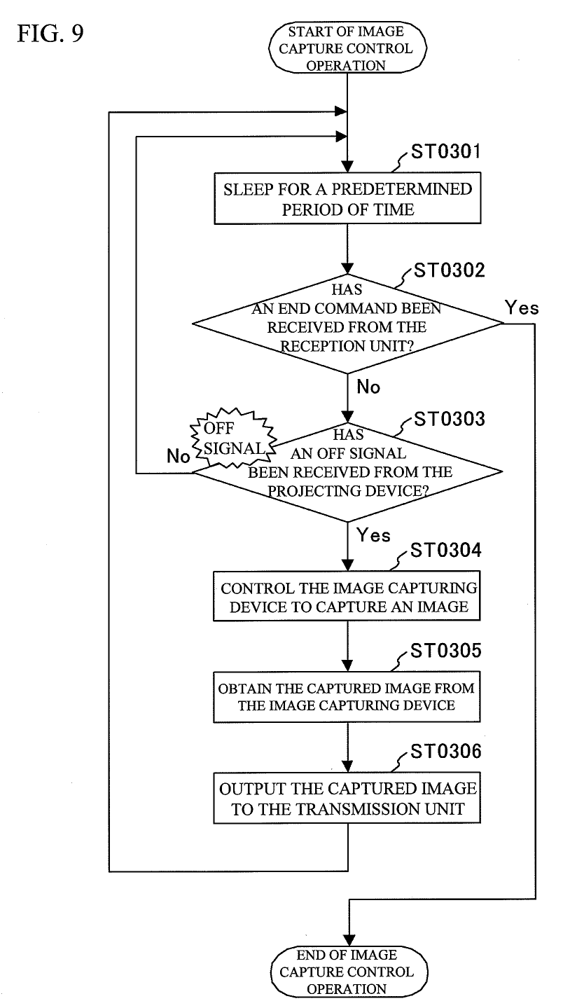

Referring now to FIG. 9, the image capture control operation to be performed by the image capture controller 1023 is described. FIG. 9 is a flowchart showing an example of the image capture control operation to be performed by the image capture controller 1023.

First, the image capture controller 1023 sleeps over a predetermined period of time or until the OFF signal is received from the projecting device 1100 (step ST0301). The image capture controller 1023 determines whether the end command has been received through the reception unit 1011 (step ST0302). If the end command has been received, the image capture controller 1023 ends the image capture control operation. If the end command has not been received, the image capture controller 1023 carries out the procedure of step ST0303.

If the image capture controller 1023 determines in step ST0302 that the end command has not been received, the image capture controller 1023 next determines whether the OFF signal has been received from the projecting device 1100 (step ST0303). If the OFF signal has been received, the image capture controller 1023 carries out the procedure of step ST0304. If the OFF signal has not been received, the image capture controller 1023 returns to step ST0301, and repeats the above procedures.

If the image capture controller 1023 determines in step ST0303 that the OFF signal has been received, the image capture controller 1023 controls the image capturing device 1200 to capture an image of the object 1900 (step ST0304).

In this exemplary embodiment, the image capturing device 1200 exposes the object during an exposure period that is shorter than the OFF period, and ends the image capturing before the projecting device 1100 starts projecting light. However, the present invention is not limited to that. For example, the image capture controller 1023 may control the image capturing device 1200 to expose the object over an exposure period that is shorter than the OFF period.

The image capture controller 1023 then obtains the captured image from the image capturing device 1200 (step ST0305). The image capture controller 1023 outputs the captured image to the transmission unit 1012 (step ST0306). The transmission unit 1012 transmits the captured image to a projection commanding device 2000. After that, the image capture controller 1023 returns to step ST0301, and repeats the above procedures.

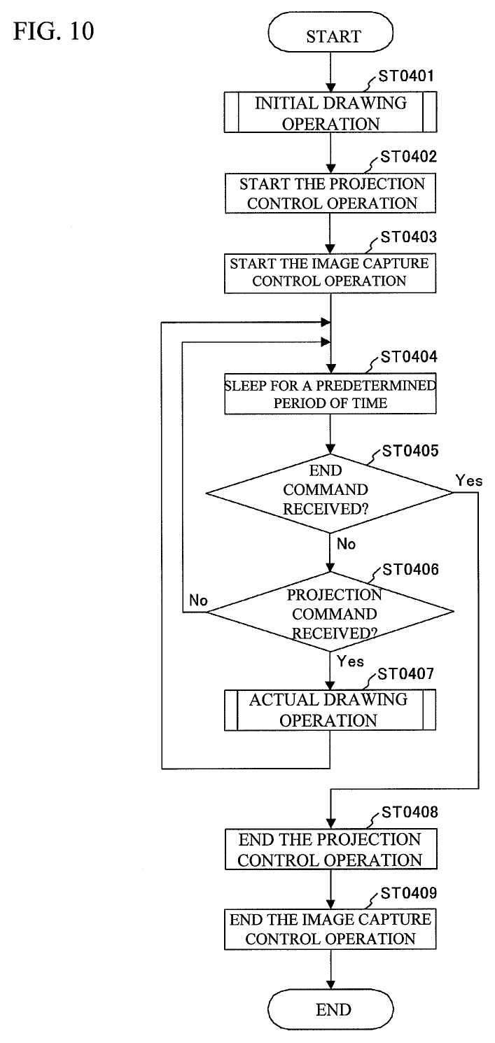

Referring now to FIG. 10, the control operation to be performed by the controller 1020 is described. FIG. 10 is a flowchart showing an example of the control operation to be performed by the controller 1020.

First, the controller 1020 performs the initial drawing operation (step ST0401). The controller 1020 starts performing the projection control operation (step ST0402). The controller 1020 performs the projection control operation and the control operation in a parallel manner, using threads or processes, for example.

After that, the controller 1020 starts performing the image capture control operation (step ST0403). The controller 1020 performs the image capture control operation and the control operation in a parallel manner, like performing the projection control operation and the control operation in a parallel manner.

The controller 1020 then sleeps for a predetermined period of time (step ST0404). After that, the controller 1020 determines whether the end command has been received through the reception unit 1011 (step ST0405). If the end command has been received, the controller 1020 carries out the procedure of step ST0408. If the end command has not been received, the controller 1020 carries out the procedure of step ST0406.

If the controller 1020 determines in step ST0405 that the end command has not been received, the controller 1020 next determines whether the projection command has been received through the reception unit 1011 (step ST0406). If the projection command has been received, the controller 1020 carries out the procedure of step ST0407. If the projection command has not been received, the controller 1020 returns to step ST0404, and repeats the above procedures.

If the controller 1020 determines in step ST0406 that the projection command has been received, the controller 1020 performs the actual drawing operation (step ST0407). The controller 1020 then returns to step ST0404, and repeats the above procedures.

If the controller 1020 determines in step ST0405 that the end command has been received, the controller 1020 ends the projection control operation (step ST0408).

The controller 1020 then ends the image capture control operation (step ST0409). The procedures of steps ST0408 and ST0409 are carried out to output a signal (SIGTERM or SIGKILL) to the process for performing the projection control operation and the process for performing the image capture control operation, for example. After that, the controller 1020 ends the control operation.

In this exemplary embodiment, the image capturing device 1200 autonomously captures an image through exposure over a predetermined period of time. Therefore, the controller 1020 is designed to control the timing for starting the image capture performed by the image capturing device 1200 based on the OFF signal output from the projecting device 1100, and control the timing for starting the projection performed by the projecting device 1100 when the exposure by the image capturing device 1200 is finished.

In this exemplary embodiment, the controller 1020 performs the timing control operations so as to control the image capturing device 1200 to capture an image between the time when the projecting device 1100 ends the light projection onto the object 1900 and the time when the projecting device 1100 starts the next light projection. However, the present invention is not limited to this arrangement.

For example, the projecting device 1100 may autonomously project light over a predetermined period of time, so as to project an annotation image. The controller 1020 may be designed to control the timing for starting the projection performed by the projecting device 1100 based on the OFF signal output from the image capturing device 1200, and control the timing for starting the image capture performed by the image capturing device 1200 when the projection by the projecting device 1100 is finished.

In short, the controller 1020 may be designed to perform the timing control operations to control the projecting device 1100, so that the image capturing device 1200 captures an image between the time when the projecting device 1100 ends the light projection onto the object 1900 and the time when the projecting device 1100 starts the next projection.

Referring back to FIG. 3, explanation of the structure of the image transmitting device 1000 is continued.

The memory 1030 is connected to the controller 1020. The memory 1030 stores the above described information and the above described images. The controller 1020 refers to the information and the images stored in the memory 1030.

Referring back to FIG. 1, explanation of the structure of the indicator system 10 is resumed.

The projection commanding system 200 is a system that issues a command to project an annotation image onto the object 1900.

The projection commanding system 200 includes a projection commanding device 2000, a display device 2100, and an input device 2200.

The projection commanding device 2000 may be formed with a personal computer, for example, and is connected to the display device 2100, the input device 2200, and the communication network 150.

The projection commanding device 2000 performs a later described projection commanding operation to transmit a projection command to project an annotation image onto the object 1900. The annotation image indicates an annotation about the object 1900 captured in a captured image transmitted from the image transmitting device 1000.

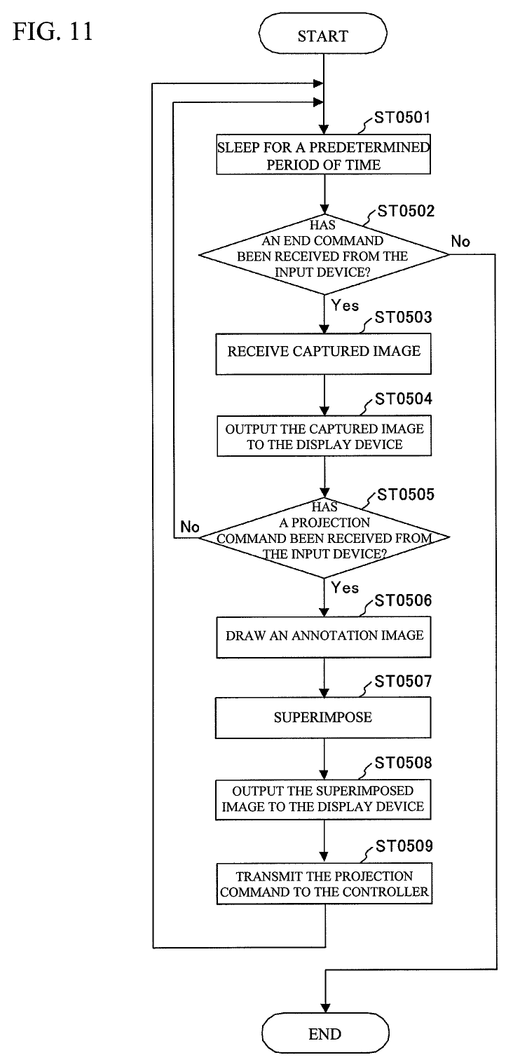

Referring now to FIG. 11, the projection commanding operation to be performed by the projection commanding device 2000 is described. FIG. 11 is a flowchart showing an example of the projection commanding operation to be performed by the projection commanding device 2000.

First, the projection commanding device 2000 sleeps for a predetermined period of time (step ST0501). The projection commanding device 2000 determines whether an end command has been received from the input device 2200 (step ST0502). If the end command has been received, the projection commanding device 2000 carries out the procedure of step ST0503. If the end command has not been received, the projection commanding device 2000 ends the projection commanding operation.

If the projection commanding device 2000 determines in step ST0502 that the end command has not been received, the projection commanding device 2000 receives an image capturing the object 1900 from the image transmitting device 1000 (step ST0503).

The projection commanding device 2000 then outputs the captured image to the display device 2100, and controls the display device 2100 to display the captured image (step ST0504).

The projection commanding device 2000 next determines whether a projection command input through the input device 2200 operated by the user of the projection commanding device 2000 has been received (step ST0505). If the projection command has been received, the projection commanding device 2000 carries out the procedure of step ST0506. If the projection command has not been obtained, the projection commanding device 2000 returns to step ST0501, and repeats the above procedures.

If the projection commanding device 2000 determines in step ST0505 that the projection command has been received, the projection commanding device 2000 draws an annotation image in accordance with the projection command (step ST0506).

After that, the projection commanding device 2000 superimposes the drawn annotation image onto a portion designated through the projection command (step ST0507). The annotation image with respect to the object 1900 captured in the captured image is to be projected onto the portion.

The projection commanding device 2000 then outputs the superimposed image to the display device 2100, and controls the display device 2100 to display the image showing the object 1900 and the image indicating the annotation at the portion of the object 1900 designed through the projection command to project the annotation image (step ST0508).

After that, the projection commanding device 2000 transmits the projection command to the image transmitting device 1000 (step ST0509). The projection commanding device 2000 then returns to step ST0501, and repeats the above procedures.

Referring back to FIG. 1, explanation of the structure of the indicator system 10 is continued.

The display device 2100 may be formed with a liquid crystal display, a plasma display, or a CRT (Cathode Ray Tube), for example. The display device 2100 is connected to the projection commanding device 2000. Under the control of the projection commanding device 2000, the display device 2100 displays the above described image.

The input device 2200 may be formed with a mouse, a keyboard, or a touch panel, for example. The input device 2200 is connected to the projection commanding device 2000. Operated by the user of the projection commanding device 2000, the input device 2200 inputs the above command or instruction to the projection commanding device 2000.

The communication network 150 may be formed with a LAN (Local Area Network), a WAN (Wide Area Network), a MAN (Metropolitan Area Network), or a public network, for example. The communication network 150 connects the image transmitting device 1000 and the projection commanding device 2000 to each other, so that the image transmitting device 1000 and the projection commanding device 2000 can communicate with each other.

Although the object 1900 in this exemplary embodiment is shown as a cube in the drawings, it is not limited to that. For example, the object 1900 may be a three-dimensional object such as a rectangular parallelepiped, a rectangular column, a cylindrical column, a pyramid, a circular cone, or a sphere. Alternatively, the object 1900 may be a flat object such as a sheet.

In this exemplary embodiment, the image transmitting device 1000 is equivalent to the image transmitting unit in the claims, the projecting device 1100 is equivalent to the projector in the claims, the image capturing device 1200 is equivalent to the image capturing unit in the claims, the reception unit 1011 is equivalent to the reception unit in the claims, the transmission unit 1012 is equivalent to the transmission unit in the claims, and the controller 1020 is equivalent to the controller in the claims.

### Second Exemplary Embodiment

A second exemplary embodiment of the present invention concerns an image transmission system 300 that includes a projecting device equipped with a converting unit that repeatedly performs shielding of projection light projected onto an object and filtering of light to convert the projection light into primary colors, and a reflecting unit that reflects the projection light converted by the converting unit to indicate an annotation image.

The image transmission system 300 in accordance with the second exemplary embodiment includes an image transmitting device 3000, a projecting device 3100, an image capturing device 3200, a half mirror 3300, and an object 3900.

The connections, structures, and functions of the image transmitting device 3000, the projecting device 3100, the image capturing device 3200, the half mirror 3300, and the object 3900 are substantially the same as the connections, structures, and functions of the image transmitting device 1000, the projecting device 1100, the image capturing device 1200, the half mirror 1300, and the object 1900 described in the first exemplary embodiment. Therefore, the differences between the two exemplary embodiments will be described in the following. As for the projecting device 3100, however, the same aspects and the different aspects in comparison with the projecting device 1100 will be described.

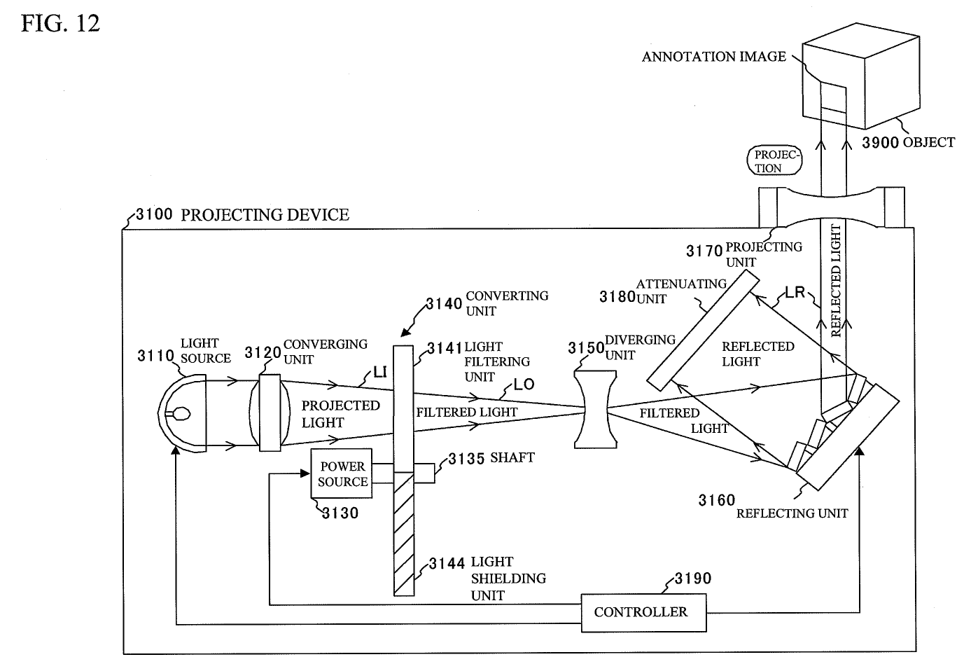

Referring now to FIG. 12, the structure of the projecting device 3100 of the second exemplary embodiment is described. FIG. 12 illustrates a situation where the projecting device 3100 is projecting light.

The projecting device 3100 includes a light source 3110, a converging unit 3120, a power source 3130, a converting unit 3140, a diverging unit 3150, a reflecting unit 3160, a projecting unit 3170, an attenuating unit 3180, and a controller 3190.

Likewise, the projecting device 1100 of the first exemplary embodiment includes a light source 1110, a converging unit 1120, a power source 1130, a converting unit 1140, a diverging unit 1150, a reflecting unit 1160, a projecting unit 1170, an attenuating unit 1180, and a controller 1190.

The connections, structure, and function of the converting unit 3140 of the second exemplary embodiment differ from the connections, structure, and function of the converting unit 1140. On the other hand, the connections, structures, and functions of the light source 3110, the converging unit 3120, the power source 3130, the diverging unit 3150, the reflecting unit 3160, the projecting unit 3170, the attenuating unit 3180, and the controller 3190 are substantially the same as the connections, structures, and functions of the light source 1110, the converging unit 1120, the power source 1130, the diverging unit 1150, the reflecting unit 1160, the projecting unit 1170, the attenuating unit 1180, and the controller 1190.

The light source 3110 is formed with a ultrahigh-pressure mercury lamp or a LED (Light Emitting Diode), for example, and is connected to the controller 3190. Under the control of the controller 3190, the light source 3110 emits the white light to be projected onto the object 3900. The light emitted by the light source 3110 is projected as projection light LI onto the converging unit 3120.

The converging unit 3120 is formed with a converging lens, for example. The light emitted from the light source 3110 is projected onto the converging unit 3120. The converging unit 3120 causes the projected light to converge, and then projects the convergent light onto the converting unit 3140.

The power source 3130 is formed with a stepping motor, for example, and is connected to a shaft 3135 and the controller 3190. Under the control of the controller 3190, the power source 3130 generates the power for rotating the shaft 3135 by a predetermined amount.

The converting unit 3140 is formed with a color filter, for example. The converting unit 3140 repeatedly performs the shielding of the projection light LI to be projected onto the object 3900, and the transmission of light to convert the projection light LI to primary colors. The converting unit 3140 transmits and projects the projection light LI caused to converge by the converging unit 3120 onto the diverging unit 3150.

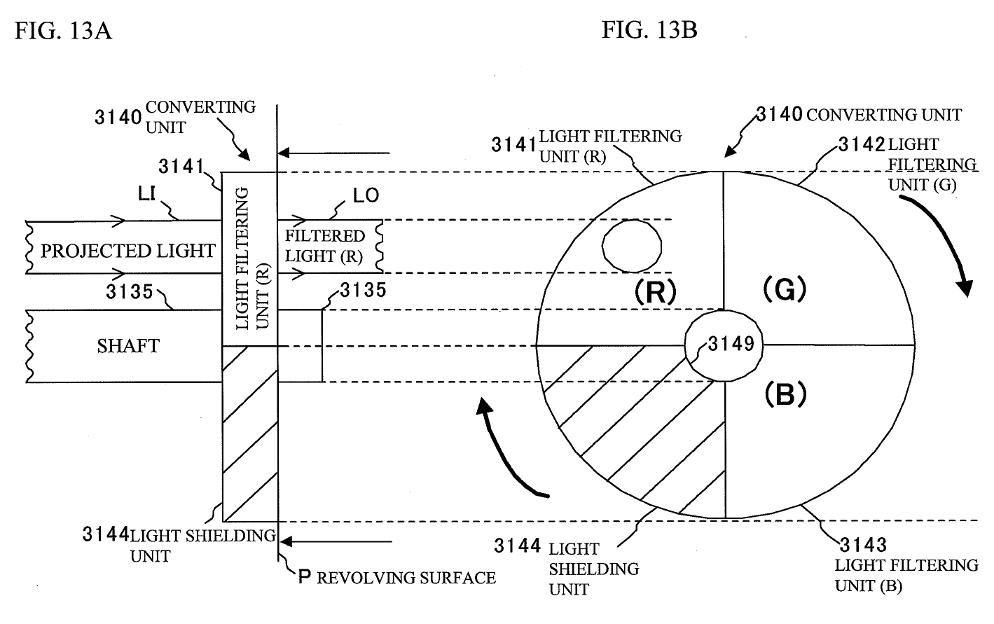

Referring now to FIGS. 13A and 13B, the structure of the converting unit 3140 is described. FIGS. 13A and 13B illustrate an example structure of the converting unit 3140. FIG. 13A is a side view of the converting unit 3140, and FIG. 13B is a top view of the converting unit 3140.

As shown in FIGS. 13A and 13B, the converting unit 3140 has a wheel-like shape. The converting unit 3140 has a hole 3149 at its center. The shaft 3135 serving as an axle is inserted through the hole 3149. The converting unit 3140 is secured by the shaft 3135 inserted through the hole 3149. As the shaft 3135 revolves like an axle, the converting unit 3140 revolves like a wheel.

The converting unit 3140 is perpendicular to the revolving surface P. The converting unit 3140 is formed with light filtering units 3141 through 3143 partitioned by planes extending through the center of the converting unit 3140, and a light shielding unit 3144.

The light filtering unit 3141 filters the projection light LI as the white light, so as to convert the projection light LI to red light (hereinafter also referred to simply as R-light). Red is one of the three primary colors of light. Likewise, the light filtering units 3142 and 3143 convert the projection light LI into green light and blue light (hereinafter also referred to simply as G-light and B-light). The light shielding unit 3144 shields the projection light LI.

The converting unit 1140 of the projecting device 1100 described in the first exemplary embodiment differs from the converting unit 3140 of the projecting device 3100 of the second exemplary embodiment, in having a light transmitting unit 1144 that transmits the projection light as the white light, as well as the light filtering units 1141 through 1143 equivalent to the light filtering units 3141 through 3143.

In this exemplary embodiment, the proportions of the light filtering units 3141 through 3143 and the light shielding unit 3144 to the converting unit 3140 are equal to one another. However, the present invention is not limited to this structure, and it is possible to employ a structure having the light filtering units 3141 through 3143 and the light shielding unit 3144 in more preferable proportions based on experiments or a theory.

Referring back to FIG. 12, explanation of the structure of the projecting device 3100 is continued.

In FIG. 12, the light filtering unit 3141 of the converting unit 3140 is crossing the traveling path of the projection light LI. Accordingly, the projection light LI is not shielded, but is filtered and converted into red light. The filtered light LO converted into red light travels to the diverging unit 3150.

The diverging unit 3150 is formed with a diverging lens, for example. The light LO converted by the converting unit 3140 is projected onto the diverging unit 3150. The diverging unit 3150 causes the projected light to diverge to the reflecting unit 3160.

The reflecting unit 3160 is formed with a DMD (Digital Mirror Device), for example, and is connected to the controller 3190. Under the control of the controller 3190, the reflecting unit 3160 reflects the projection light LI converted by the converting unit 3140 onto the object 3900 to show an annotation image.

More specifically, the reflecting unit 3160 has micromirrors arranged in a grid-like fashion that conforms to the pixels. As the micromirrors can change the reflecting direction, the reflecting unit 3160 can reflect light toward the object 3900 via the projecting unit 3170, or reflects light toward the attenuating unit 3180. Under the control of the controller 3190, the reflecting unit 3160 reflects the projection light to indicate an annotation image.

The projecting unit 3170 is formed with a diverging lens, for example. The projecting unit 3170 causes the light LO reflected from the reflecting unit 3160 to diverge to the object 3900. In this manner, the projecting unit 3170 projects the annotation image onto the object 3900.

The attenuating unit 3180 is formed with an optical attenuator, for example. The attenuating unit 3180 is located in such a position that does not interfere with the traveling path of the light reflected by the reflecting unit 3160 toward the object 3900, and receives the light reflected to diverge from the path to the object 3900. The attenuating unit 3180 causes attenuation of the reflected light diverged from the path to the object 3900.

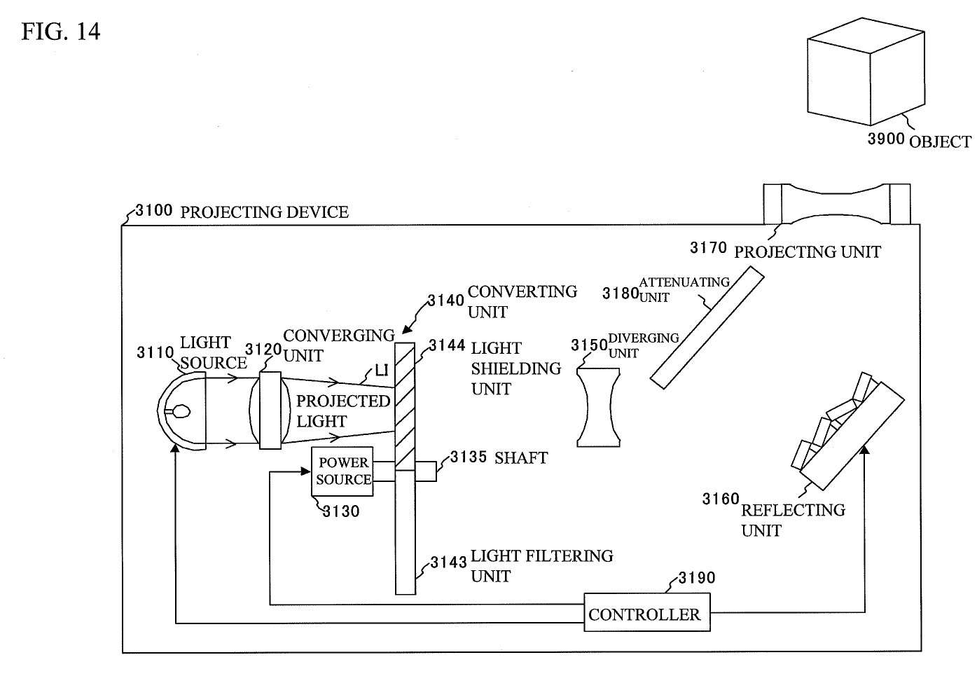

Referring now to FIG. 14, a situation where the image capturing device 3200 is not projecting light is described. FIG. 14 illustrates a situation where the image capturing device 3200 is not projecting light.

In FIG. 14, the light shielding unit 3144 of the converting unit 3140 is crossing the traveling path of the projection light LI. Accordingly, the projection light LI is not filtered, but is shielded. While the light shielding unit 3144 is crossing the traveling path of the projection light LI, the projecting device 3100 stops projecting light.

Referring back to FIG. 12, explanation of the structure of the projecting device 3100 is continued.

The controller 3190 is formed with a DLP (Digital Light Processing) board, for example. The controller 3190 is connected to the light source 3110, the power source 3130, and the reflecting unit 3160. The controller 3190 performs the later described control operation, so as to control the light source 3110, the power source 3130, and the reflecting unit 3160.

The hardware structure to be used by the controller 3190 to perform the control operation is the same as the hardware structure used by the image transmitting device 1000 to perform the software control in the first exemplary embodiment. Therefore, explanation of the hardware structure is omitted here.

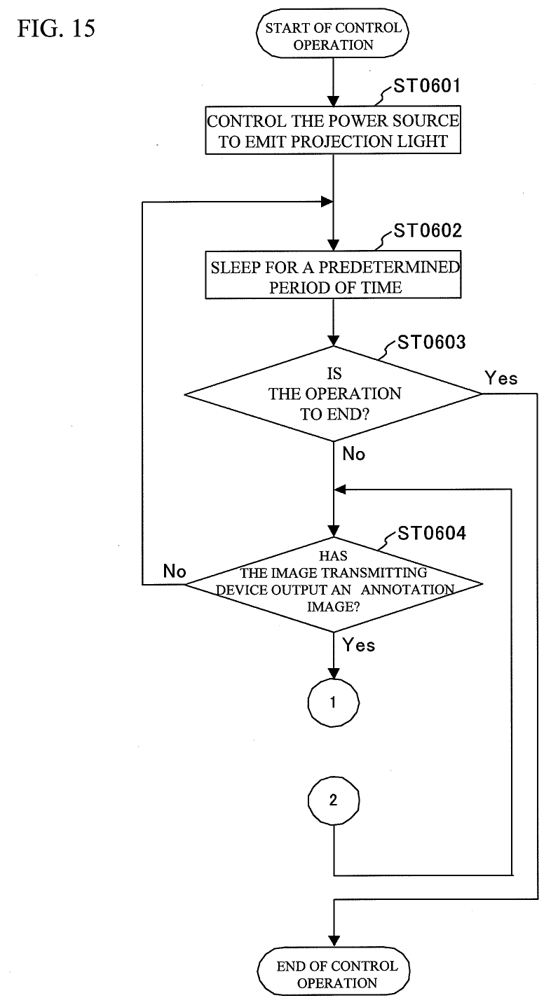

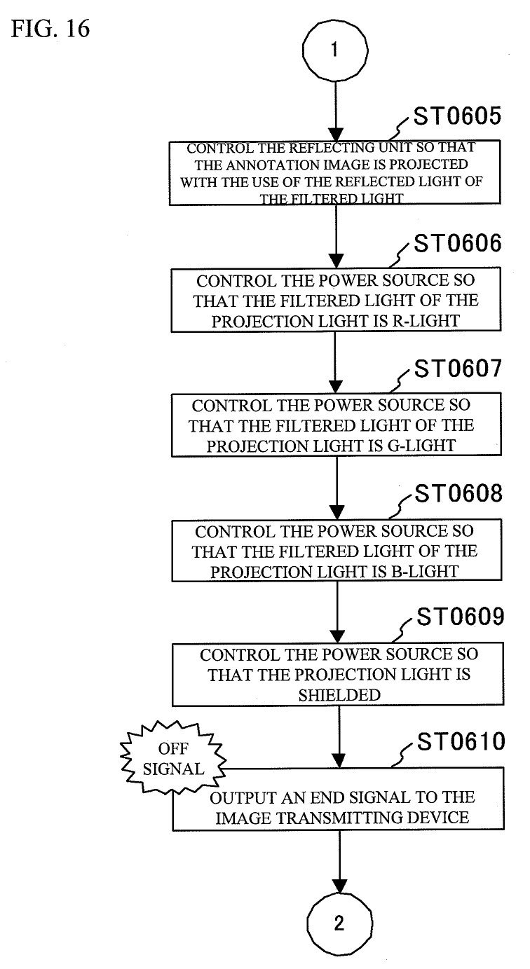

Referring now to FIGS. 15 and 16, the control operation to be performed by the controller 3190 is described. FIG. 15 is a flowchart showing part of an example of the control operation to be performed by the controller 3190. FIG. 16 is a flowchart showing the remaining part of the example of the control operation to be performed by the controller 3190.

First, the controller 3190 controls the light source 3110 to emit the projection light LI (step ST0601). The controller 3190 then sleeps for a predetermined period of time (ST0602).

The controller 3190 determines whether to end the control operation (ST0603). If the controller 3190 determines to end the control operation, the control operation comes to an end. If the controller 3190 determines not to end the control operation, the controller 3190 carries out the procedure of step ST0604.

Where the controller 3190 determines to end the control operation, the input unit (not shown) of the projecting device 3100 has received a command to end the operation, for example.

If the controller 3190 determines not to end the control operation in step ST0603, the controller 3190 determines whether the image transmitting device 3000 has output an annotation image (step ST0604). In a case where the image transmitting device 3000 has output an annotation image, the controller 3190 carries out the procedure of step ST0605. In a case where the image transmitting device 3000 has not output an annotation image, the controller 3190 returns to step ST0602, and repeats the above procedures.

If the controller 3190 determines in step ST0604 that an annotation image has been output, the controller 3190 controls the reflecting unit 3160 to project the annotation image with the use of the reflected light LR of the filtered light L converted by the converting unit 3140 (step ST0605).

The controller 3190 then controls the power source 3130 to turn the filtered light LO of the projection light into red light (R-light) (step ST0606). More specifically, the controller 3190 controls the amount of power to be generated from the power source 3130, so that the light filtering unit 3141 crosses the traveling path of the projection light LI.

Likewise, the controller 3190 then controls the power source 3130 to turn the filtered light LO of the projection light into green light (G-light) (step ST0607). The controller 3190 further controls the power source 3130 to turn the filtered light LO of the projection light into blue light (B-light) (step ST0608).

After that, the controller 3190 controls the power source 3130 to shield the projection light LI (step ST0609). More specifically, the controller 3190 controls the amount of power to be generated by the power source 3130, so that the light shielding unit 3144 crosses the traveling path of the projection light LI.

In this exemplary embodiment, the controller 3190 is designed to control the power source 3130 in such a manner that the length of time for shielding the projection light LI is longer than the length of the predetermined exposure period of the image capturing device 3200.

The controller 3190 is also designed to control the length of time for shielding the projection light and the length of time for projecting the filtered light onto the object 3900, so that a continuous length of time is formed in an artificial manner.

The length of time for shielding the projection light and the length of time for projecting the filtered light are determined by the intensity of the light projected by the projecting unit 3160. Accordingly, a suitable length of time can be set for each of the lengths of time, based on experiments or a theory. In this exemplary embodiment, the length of time for shielding the projection light is 1/30 seconds or less, as in the first exemplary embodiment.

The controller 3190 then outputs an end signal to the image transmitting device 1000 (step ST0610). The controller 3190 then returns to step ST0604, and repeats the above procedures.

Explanation of the structure of the image transmitting system 300 is now resumed.

The image transmitting device 3000 includes a communication unit 3010 formed with a reception unit 3011 and a transmission unit 3012, a controller 3020, and a memory 3030. The connections, structures, and functions of the communication unit 3010 formed with the reception unit 3011 and the transmission unit 3012, the controller 3020, and the memory 3030 are substantially the same as the connections, structures, and functions of the communication unit 1010 formed with the reception unit 1011 and the transmission unit 1012, the controller 1020, and the memory 1030 of the image transmitting device 1000 of the first embodiment. Therefore, the different aspects between the two exemplary embodiments will be described in the following.

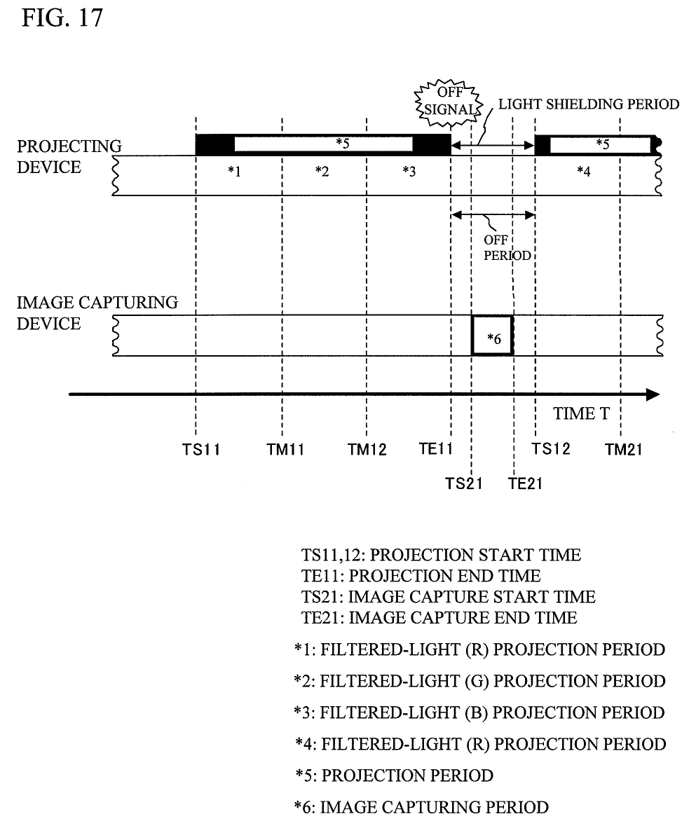

Referring now to FIG. 17, a control operation to be performed by the controller 3020 is briefly described.

FIG. 17 schematically shows an example of the control operation to be performed by the controller 3020.

The projection period in the second exemplary embodiment includes: a filtered-light (R) projection period that is defined by a projection start time TS11 and a time TM11; a filtered-light (G) projection period that is defined by the time TM11 and a time TM12; and a filtered-light (B) projection period that is defined by the time TM12 and a projection end time TE11.

The filtered-light (R) projection period, the filtered-light (G) projection period, and the filtered-light (B) projection period are the lengths of time for projecting an annotation image by emitting R-light, G-light, and B-light, which are the primary colors. Also, the OFF period in the second exemplary embodiment is the time during which the shielding unit 3144 shields the projection light LI. Therefore, the OFF period is also referred to as the light shielding time.

Unlike the controller 1020 of the first exemplary embodiment, the controller 3020 first outputs an annotation image to the projecting device 1100, so that the annotation image is projected not only during the projection period defined by the projection start time TS11 and the projection end time TE11, but also after the projection end time TE11.

Unlike the controller 1020 of the first exemplary embodiment, the controller 3020 does not control the projecting device 1100 during the OFF period defined by the projection end time TE11 and the next projection start time TS12, so that the projecting device 1100 does not project light during the OFF period. The projecting device 1100 spontaneously stops the light projection during the OFF period.

Like the controller 1020 of the first exemplary embodiment, the controller 3020 then controls the image capturing device 1200 to start capturing an image of the object 3900, after receiving an OFF signal output from the projecting device 3100 during the OFF period. The controller 3020 repeats the above procedures.

Explanation of the structure of the image transmitting system 300 is now resumed.

The controller 3020 includes a drawing unit 3021, a projection controller 3022, and an image capture controller 3023. The drawing unit 3021, the projection controller 3022, and the image capture controller 3023 are the same as the drawing unit 1021, the projection controller 1022, and the image capture controller 1023 described in the first exemplary embodiment.

The connections, structures, and functions of the drawing unit 3021, the projection controller 3022, and the image capture controller 3023 are substantially the same as the connections, structures, and functions of the drawing unit 1021, the projection controller 1022, and the image capture controller 1023. Therefore, the different aspects between the two exemplary embodiments will be described in the following.

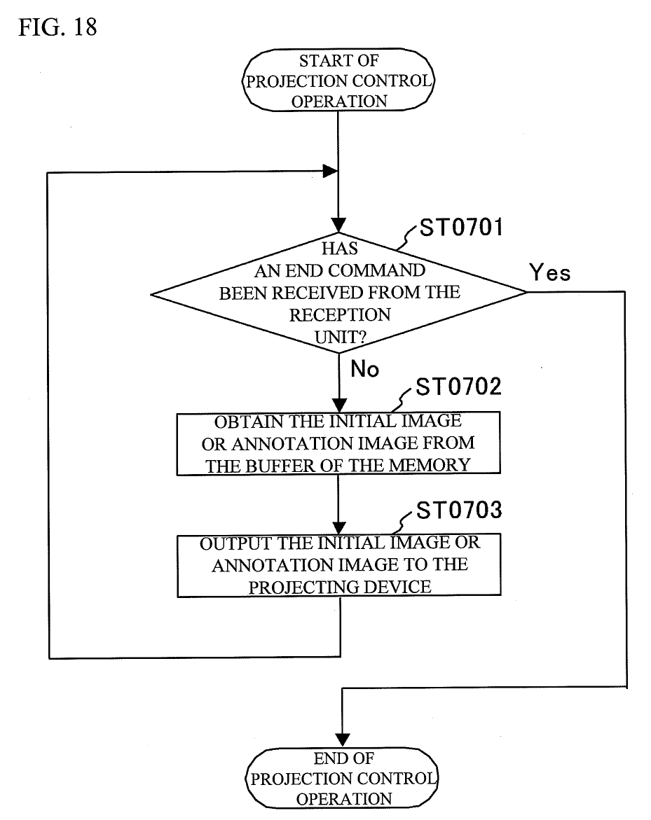

Referring now to FIG. 18, the projection control operation to be performed by the projection controller 3022 is described. FIG. 18 is a flowchart showing an example of the projection control operation to be performed by the projection controller 3022 in the second exemplary embodiment.

First, the projection controller 3022 first determines whether an end command has been received from the reception unit 3011 (step ST0701). In a case where an end command has been received, the projection controller 3022 ends the projection control operation. In a case where an end command has not been received, the projection controller 3022 carries out the procedure of step ST0702.

If the projection controller 3022 determines in step ST0701 that an end command has not been received, the projection controller 3022 obtains an initial image or an annotation image from a buffer of the memory 3030 (step ST0702). After that, the projection controller 3022 outputs the initial image or the annotation image to the projecting device 3100 (step ST0703). After that, the projection controller 3022 returns to step ST0710, and repeats the above procedures.

Although the converting unit 3140 has the light shielding unit 3144 in this exemplary embodiment, the present invention is not limited to that structure. For example, the converting unit 3140 may have a light transmitting unit in place of the light shielding unit 3144, as in the first exemplary embodiment. The projecting unit 3170 may be formed with a shutter, for example, and may have a light shielding unit that shields the reflected light LR reflected by the reflecting unit 3160. The controller 3190 may control the light shielding unit of the projecting unit 3170 so as to shield the reflected light at predetermined time intervals.

In this exemplary embodiment, the image transmitting device 3000 is equivalent to the image transmitting unit in the claims, the projecting device 3100 is equivalent to the projector in the claims, the image capturing device 3200 is equivalent to the image capturing unit in the claims, the reception unit 3011 is equivalent to the reception unit in the claims, the transmission unit 3012 is equivalent to the transmission unit in the claims, the controller 3020 is equivalent to the controller in the claims, the converting unit 3140 is equivalent to the converter in the claims, and the reflecting unit 3160 is equivalent to the reflecting unit in the claims.

### Third Exemplary Embodiment

A third exemplary embodiment of the present invention concerns an image transmission system 500 that includes a projecting device equipped with a converting unit and a reflecting unit. The converting unit repeatedly performs shielding of projection light projected onto an object and filtering of light to convert the projection light into primary colors. The reflecting unit reflects the projection light converted by the converting unit to indicate an annotation image, and also reflects and causes the projection light passing through the converting unit to diverge from the path to the object.

The image transmission system 500 in accordance with the third exemplary embodiment includes an image transmitting device 5000, a projecting device 5100, an image capturing device 5200, a half mirror 5300, and an object 5900.

The connections, structures, and functions of the image transmitting device 5000, the projecting device 5100, the image capturing device 5200, the half mirror 5300, and the object 5900 are substantially the same as the connections, structures, and functions of the image transmitting device 3000, the projecting device 3100, the image capturing device 3200, the half mirror 3300, and the object 3900 described in the second exemplary embodiment. Therefore, the differences between the two exemplary embodiments will be described in the following. As for the projecting device 5100, however, the same aspects and the different aspects in comparison with the projecting device 3100 will be described.

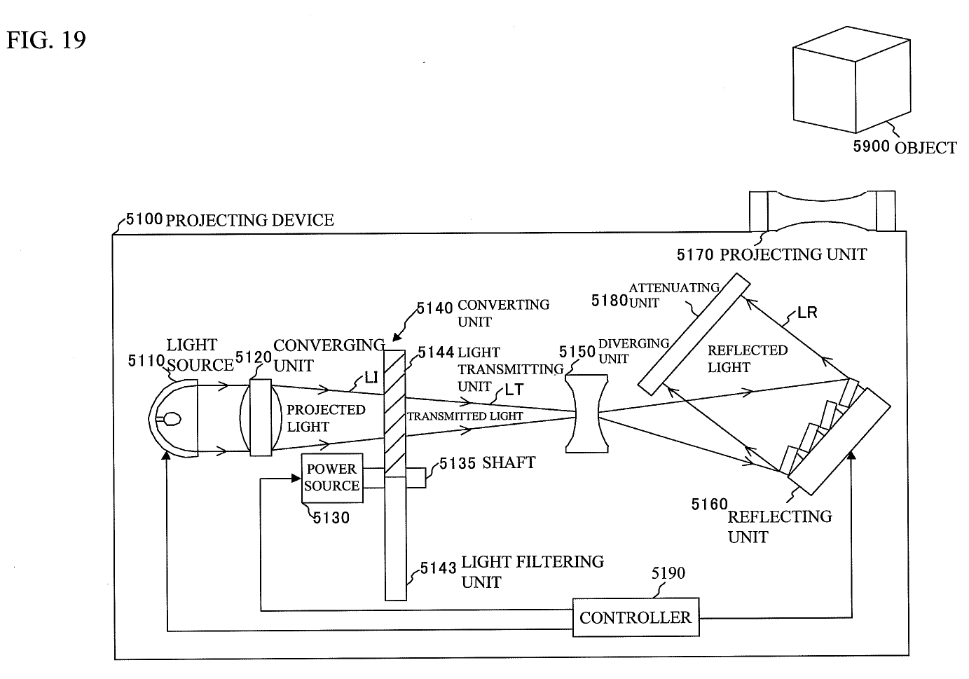

Referring now to FIG. 19, the structure of the projecting device 5100 of the third exemplary embodiment is described. FIG. 19 illustrates a situation where the projecting device is not projecting light.

The projecting device 5100 includes a light source 5110, a converging unit 5120, a power source 5130, a converting unit 5140, a diverging unit 5150, a reflecting unit 5160, a projecting unit 5170, an attenuating unit 5180, and a controller 5190.

The connections, structures, and functions of the light source 5110, the converging unit 5120, the power source 5130, the converting unit 5140, the diverging unit 5150, the reflecting unit 5160, the projecting unit 5170, the attenuating unit 5180, and the controller 5190 are substantially the same as the connections, structures, and functions of the light source 3110, the converging unit 3120, the power source 3130, the converting unit 3140, the diverging unit 3150, the reflecting unit 3160, the projecting unit 3170, the attenuating unit 3180, and the controller 3190. Therefore, the different aspects between the second exemplary embodiment and the third exemplary embodiment will be described in the following.

The structure and functions of the converting unit 5140 of the third exemplary embodiment differ from the structure and functions of the converting unit 3140 of the second exemplary embodiment, but are the same as the structure and functions of the converting unit 1140 of the first exemplary embodiment.

The converting unit 5140 repeatedly performs transmission of the projection light LI to be projected onto the object 5900, and light filtering to convert the projection light L into the primary colors.

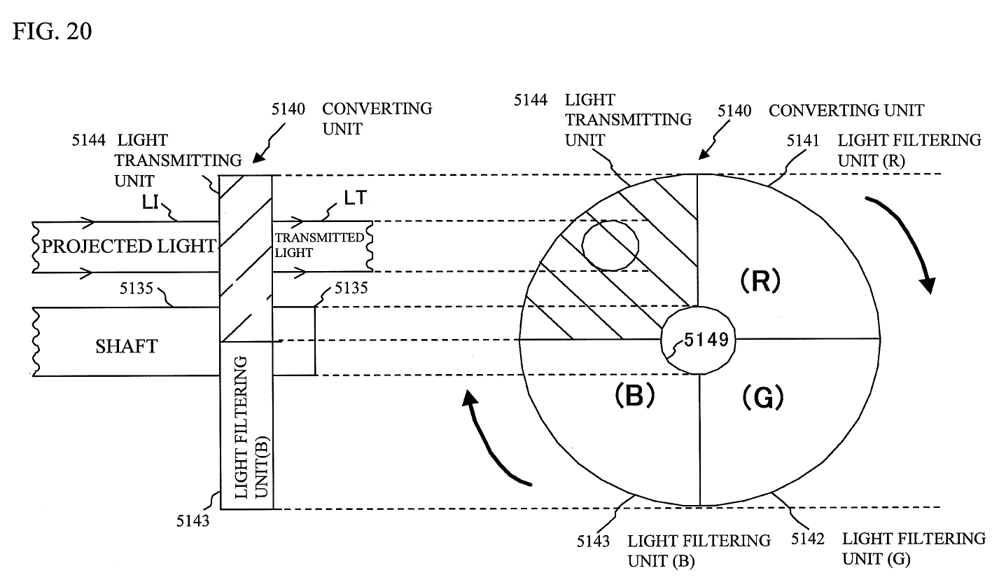

Referring now to FIG. 20, the structure of the converting unit 5140 is described. FIG. 20 illustrates an example structure of the converting unit 5140. FIG. 20 shows a side view of the converting unit 5140, and a top view of the converting unit 5140.

The converting unit 5140 is perpendicular to the revolving surface P. The converting unit 5140 is formed with light filtering units 5141 through 5143 partitioned by planes extending through the center of the converting unit 5140, and a light transmitting unit 5144.

The structures and functions of the light filtering units 5141 through 5143 are the same as the structures and functions of the light filtering units 3141 through 3143 of the second exemplary embodiment, and therefore, explanation of those is omitted here. The light transmitting unit 5144 allows the projection light LI as white light to pass as it is.

In this exemplary embodiment, the proportions of the light filtering units 5141 through 5143 and the light transmitting unit 5144 to the converting unit 5140 are equal to one another. However, the present invention is not limited to this structure, and it is possible to employ a structure having the light filtering units 5141 through 5143 and the light transmitting unit 5144 in more preferable proportions based on experiments or a theory.

Referring back to FIG. 19, explanation of the structure of the projecting device 5100 is continued.

In FIG. 19, the light transmitting unit 5144 of the converting unit 5140 is crossing the traveling path of the projection light LI. Accordingly, the projection light LI is not shielded, but is transmitted without a conversion. The transmitted light LT transmitted through the converting unit 5140 travels to the reflecting unit 5160 via the diverging unit 5150.

Under the control of the controller 5190, the reflecting unit 5160 reflects the projection light LI converted by the converting unit 3140 onto the object 5900 to indicate an annotation image, and also reflects the projection light transmitted through the converting unit 5140 so that the projection light diverges from the path to the object 5900.

More specifically, the micromirrors forming the reflecting unit 5160 are controlled by the controller 5190, and reflect the light LO filtered and converted into the primary colors by the light filtering units 5141 through 5143 of the converting unit 5140 toward the object 5900, with the respective pixels of the annotation image being associated with the micromirrors.

Under the control of the control of the controller 5190, the micromirrors forming the reflecting unit 5160 reflect all the white light transmitted through the transmitting unit 5144 of the converting unit 5140 so that the white light diverges from the path to the object 5900.

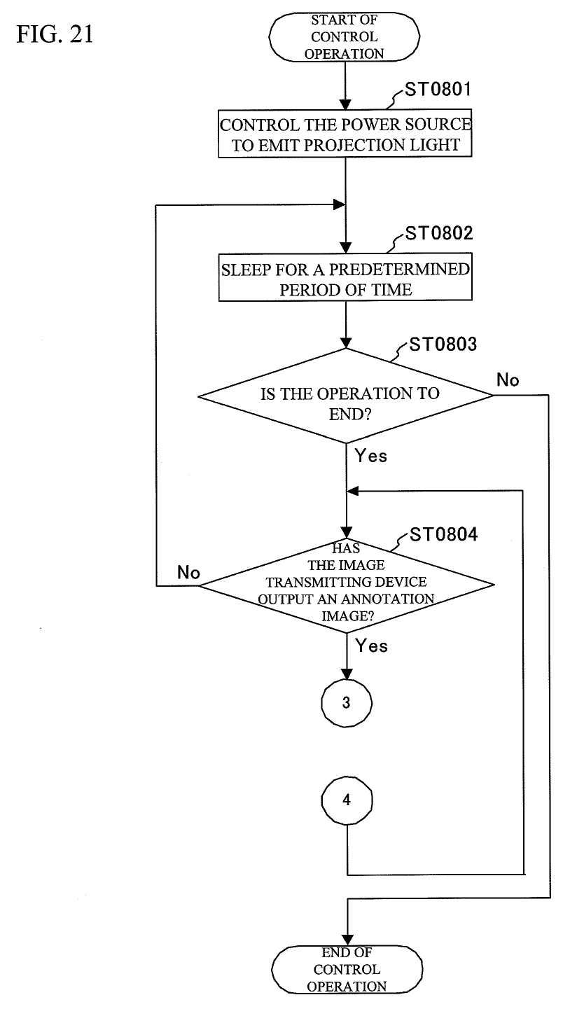

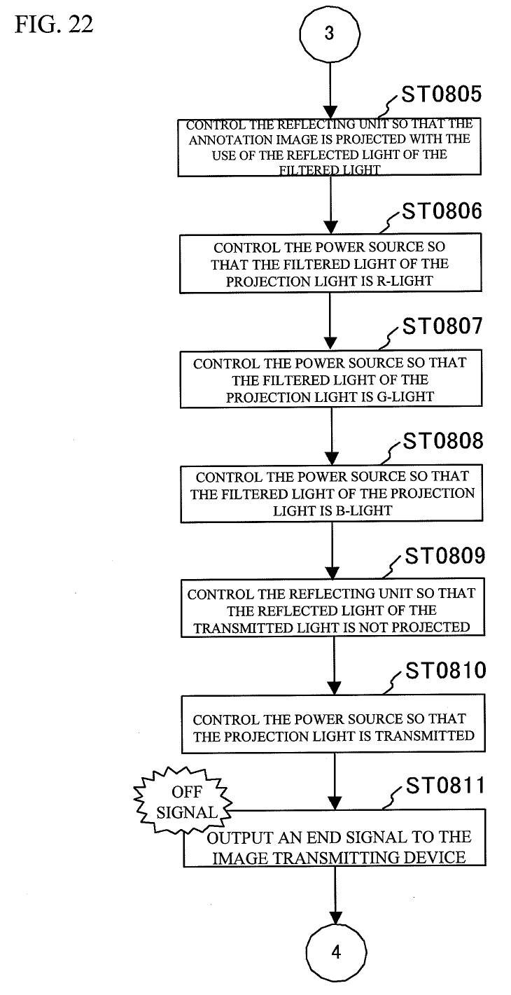

Referring now to FIGS. 21 and 22, the control operation to be performed by the controller 5190 is described. FIG. 21 is a flowchart showing part of an example of the control operation to be performed by the controller 5190. FIG. 22 is a flowchart showing the remaining part of the example of the control operation to be performed by the controller 5190.

First, the controller 5190 carries out the procedures of steps ST0801 through ST0808 (steps ST0801 through ST0808). The procedures of steps ST0801 through ST0808 are the same as the procedures of steps ST0601 through ST0608 shown in FIGS. 15 and 16, and therefore, explanation of them is omitted here.

After carrying out the procedure of step ST0808, the controller 5190 controls the reflecting unit 5160 to reflect the transmitted light LT transmitted through the converting unit 5140, so that the transmitted light LT diverges from the path to the object 5900 and does not project the reflected light LR (step ST0809).

The controller 5190 then controls the power source 5130 to allow the projection light to pass (step ST0810). More specifically, the controller 5190 controls the amount of power to be generated from the power source 5130, so that the light transmitting unit 5144 crosses the traveling path of the projection light LI.

After that, the controller 5190 carries out the procedure of step ST0811 (step ST0801). The procedure of step ST0811 is the same as the procedure of step ST0610, and therefore, explanation of it is omitted here. The controller 5190 then returns to step ST0804, and repeats the above procedures.

In this exemplary embodiment, the reflecting unit 5160 reflects the transmitted light LT as white light so that the transmitted light LT diverges from the path to the object 5900. However, the present invention is not limited to that arrangement.

For example, the reflecting unit 5160 may be designed to reflect transmitted light toward the object 5900 and to reflect transmitted light away from the path to the object 5900 in predetermined cycles or timing.

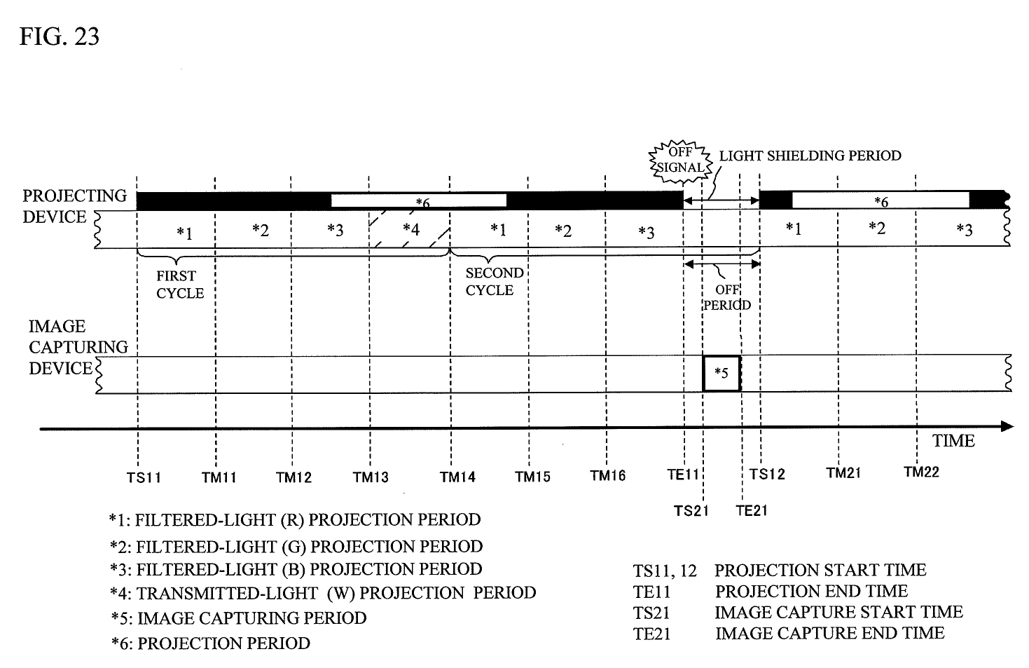

Referring now to FIG. 23, a control operation to be performed by the controller 5190 in an example structure having the above structure is briefly described. FIG. 23 schematically shows an example of the control operation to be performed by the controller 5190 in an example case where the transmitted light LT is reflected so as to diverge from the path to the object 5900 every other cycle.

The projection period defined by the projection start time TS11 and the projection end time TE11 shown in FIG. 23 includes: a filtered-light (R) projection period that is defined by the projection start time TS11 and times TM11, TM14, and TM15; a filtered-light (G) projection period that is defined by the time TM11 and times TM12, TM15, and TM16; and a filtered-light (B) projection period that is defined by the time TM12, a time TM13, the time TM16, and the projection end time TE11; and a transmitted-light (W) projection period that is defined by the times TM13 and 14.

The filtered-light (R) projection period, the filtered-light (G) projection period, and the filtered-light (B) projection period are the same as the filtered-light (R) projection period, the filtered-light (G) projection period, and the filtered-light (B) projection period of the second exemplary embodiment, and therefore, explanation of them is omitted here. The transmitted-light (W) projection period is the period of time during which the transmitted light LT as white light (hereinafter also referred to simply as W-light) is projected to indicate an annotation image.

First, the controller 5190 controls the power source 5130 to cause the converting unit 5140 to rotate one revolution during the period between the projection start time TS11 and the time TM14, and also controls the reflecting unit 5160 to reflect the filtered light LO converted by the converting unit 5140 and the transmitted light LT not converted by the converting unit 5140 toward the object 5900.

The controller 5190 then controls the power source 5130 to cause the converting unit 5140 to further rotate a ¾ revolution during the period between the time TM14 and the projection end time TE11, and also controls the reflecting unit 5160 to reflect the filtered light LO converted by the converting unit 5140 toward the object 5900.

The controller 5190 further controls the power source 5130 to cause the converting unit 5140 to rotate a ¼ revolution during the period between the projection end time TE11 and the projection start time TS12 TE11 (or during the OFF period), and also controls the reflecting unit 5160 to reflect the transmitted light LT transmitted through the converting unit 5140 so that the transmitted light LT diverges from the path to the object 5900.

At the projection end time TE11, the controller 5190 outputs an OFF signal to the image transmitting device 5000. The controller 5190 then repeats the above procedures until receiving an end command.

After receiving the OFF signal, the image transmitting device 5000 controls the image capturing device 5200 to capture an image of the object 5900 before the projection start time TS12.

In this exemplary embodiment, the image transmitting device 5000 is equivalent to the image transmitting unit in the claims, the projecting device 5100 is equivalent to the projector in the claims, the image capturing device 5200 is equivalent to the image capturing unit in the claims, the controller 5190 is equivalent to the controller in the claims, the converting unit 5140 is equivalent to the converter in the claims, and the reflecting unit 5160 is equivalent to the reflecting unit in the claims.

The image transmitting devices 1000, 3000, and 5000, and the projection commanding device 2000 are realized by the corresponding operation unit executing a program stored in at least one of the ROM and the RAM. This program may be distributed through magnetic disks, optical disks, semiconductor memories, or other recording media, or may be distributed over a network.

Although exemplary embodiments of the present invention have been described, the present invention is not limited to those specific examples, and various changes and modifications may be made to them within the scope of the claimed invention.

What is claimed is:

1. An image transmitting system comprising:
an image transmitting unit that receives a projection command to project an annotation image onto an object, and transmits a captured image formed by capturing an image of the object designated by the projection command as an object onto which the annotation image is to be projected, the annotation image representing an annotation about the object;
a projector that projects the annotation image in an artificially continuous manner, using an afterimage formed by intermittently projecting light onto the object; and
an image capturing unit that captures an image of the object including the portion onto which the light is projected during a period between a time when the projector ends the light projection onto the object and a time when the projector starts the next light projection, and forms the captured image to be transmitted by the image transmitting unit.

2. The image transmitting system as claimed in claim 1, wherein the projector includes a converter that repeatedly performs shielding of projection light to be projected onto the object and light filtering to convert the projection light into primary colors, and a reflecting unit that reflects the projection light converted by the converter toward the object to indicate the annotation image.

3. The image transmitting system as claimed in claim 1, wherein the projector includes a converter that repeatedly performs transmission of projection light to be projected onto the object and light filtering to convert the projection light into primary colors, and a reflecting unit that reflects the projection light converted by the converter toward the object to indicate the annotation image and reflects the projection light transmitted through the converter away from the object.

4. An image transmitting device comprising:
a reception unit that receives a projection command to project an annotation image representing an annotation about an object;
a controller that controls at least one of a projecting device and an image capturing device during a period between a time when the projecting device ends projection of light onto the object and a time when the projecting device starts the next light projection, the projecting device projecting the annotation image designated by the projection command received by the reception unit in an artificially continuous manner realized by using an afterimage formed by intermittently projecting the light onto the object, the image capturing device capturing an image of the object including the portion onto which the projecting device projects the light; and
a transmission unit that transmits an image formed by the image capturing device capturing the image of the object.

5. The image transmitting device as claimed in claim 4, wherein the controller performs at least one of a control operation to control the image capturing device to capture the image during a period between a time when a signal indicating an end of the light projection is received from the projecting device and a time when the projecting device starts the next light projection, and a control operation to control the projecting device to project light during a period between a time when a signal indicating an end of image capturing is received from the image capturing device and a time when the image capturing device starts the next image capturing.

6. A computer readable medium storing a program causing a computer to execute a process for transmitting an image, the process comprising:
receiving a projection command to project an annotation image representing an annotation about an object;
controlling at least one of a projecting device and an image capturing device during a period between a time when the projecting device ends projection of light onto the object and a time when the projecting device starts the next light projection, the projecting device projecting the annotation image designated by the projection command received by the reception unit in an artificially continuous manner realized by using an afterimage formed by intermittently projecting the light onto the object, the image capturing device capturing an image of the object including the portion onto which the projecting device projects the light; and
transmitting an image formed by the image capturing device capturing the image of the object.
